(19) United States
(12) Patent Application Publication
(10) Pub. No.: US 2022/0169955 A1
(43) Pub. Date: Jun. 2, 2022

(54) CLEANING COMPOSITIONS

(71) Applicant: Conopco Inc., d/b/a UNILEVER, Englewood Cliffs, NJ (US)

(72) Inventors: Shanthi Appavoo, Bangalore (IN); Rohini Sukumaran Nair, Bangalore (IN); Jayashree Anantharam Vadhyar, Bangalore (IN)

(73) Assignee: Conopco Inc., d/b/a UNILEVER, Englewood Cliffs, NJ (US)

(21) Appl. No.: 17/442,149

(22) PCT Filed: Mar. 23, 2020
(86) PCT No.: PCT/EP2020/057947

§ 371 Date: Sep. 23, 2021

(30) Foreign Application Priority Data
Feb. 4, 2019 (EP) 19166747.6

(51) Int. Cl. C11D 3/50; C11D 3/00; C11D 3/20; C11D 3/12; C11D 17/00; C11D 11/00

(52) U.S. Cl. CPC C11D 3/505; C11D 3/0094; C11D 3/2034; C11D 11/0023; C11D 3/124; C11D 17/0047; C11D 3/2024

(57) ABSTRACT

The present invention relates to impregnated inorganic porous particles comprising a eutectic mixture of thymol and menthol. The invention also relates to powder compositions comprising said particles. The invention further relates to methods of cleaning surfaces using said particles and compositions.

### FIELD OF THE INVENTION

The present invention relates to cleaning compositions. It particularly relates to particles comprising a eutectic mixture of thymol and menthol, and compositions comprising the same.

### BACKGROUND

Cleaning compositions for cleaning animate surfaces, e.g. hands, and inanimate surfaces, e.g. hard surfaces like floors, are well known and used daily by consumers around the world, with soap being one of the most recognizable cleaning compositions. Consumers use such cleaning compositions first and foremost to remove unwanted physical substances like dirt to achieve a clean look and feel. Nowadays there is an emerging desire with consumers to, in addition or instead, remove or disable unwanted physical substances like infectious agents like e.g. Escherichia coli (E. coli) and Staphylococcus aureus (S. aureus). Such infectious agents can be present on animate surfaces as well as on inanimate surfaces. Commonly used cleaning compositions include soap compositions comprising chlorine-based antimicrobial ingredients like e.g. triclosan.

For a cleaning composition to have the desired effect, a certain contact time with the surface intended to be cleaned is usually required. Generally, such contact times can be described as long, especially in relation to the time consumers usually spend on cleaning a surface. The result may be that, although physical substances like dirt may be removed and impart the impression of a clean look and feel, unwanted physical substances like infectious agents are not or only partly removed or disabled.

There is an emerging desire amongst consumers to use cleaning compositions comprising less harsh chemicals, reduced amounts of chemicals or even no chemicals at all—with the term ‘chemicals’ being understood as artificial substances, i.e. manmade ingredients. Instead, some consumers prefer cleaning compositions comprising more natural ingredients, i.e. ingredients existing in nature or derived from natural sources and preferably derived from natural sources without any artificial chemical modification of such ingredients.

GB508407 (1939) describes an antiseptic product and method of preparation thereof comprising the steps of mixing salol and thymol in a weight ratio of 1:3, melting the mixture and cooling to form crystals. An example of a composition comprising 59 parts of the crystals, 41 parts of terpineol, 200 parts of red turkey oil and 200 parts of water is described. The composition described in this document comprises about 8% by weight thymol and about 8% by weight terpineol and is said to be particularly useful for disinfection of air.

U.S. Pat. No. 6,534,042 (Pfizer, 2003) describes an oral care composition comprising from 0.01 to 5% by weight of citrus flavour or citrus flavour ingredient and from 0.01 to 5% by weight a phenolic selected from the group consisting of menthol eucalyptol, methyl salicylate, thymol, triclosan and mixtures thereof, and an orally acceptable carrier. The citrus flavour ingredient is selected from the group consisting of limonene, citral, cadiene, decylaldehyde, linalool, terpineol, linalyl esters, terpinyl acetate, citronellol, alpha-terpinene, 2-dodecanal, alpha-pinene, beta-pinene, 3-penternal, decanal, and C8 to C10 and C12 aldehydes, acids, and esters found in citrus flavours and mixtures thereof. The oral care composition is said to be useful in retarding development of plaque, treating gingivitis and reducing viable population of microorganisms in oral cavity.

None of the patents cited above address the problem of slow-acting antimicrobial compositions.

WO2010/046238 (Unilever) discloses an antimicrobial composition comprising thymol, terpineol, anionic surfactant and carrier, such compositions providing relatively quick antimicrobial action.

Some antimicrobial ingredients do not dissolve or readily dissolve in water and may require e.g. surfactants to allow such ingredients to be effective against unwanted physical substances like infectious agents. Not using a surfactant may require more antimicrobial ingredient to achieve the desired effect. Using more of such an antimicrobial ingredient may result in unwanted properties like e.g. ‘oil blobs’ or excessive smell. It may also be more expensive. It is not always desired to use a surfactant as some consumers prefer products having none or only limited amounts thereof.

There is a need for cleaning products that give relatively more efficacious antimicrobial action, preferably in a shorter time and preferably whilst using limited amounts of antimicrobial ingredients.

### SUMMARY OF THE INVENTION

We have found that using a eutectic mixture of thymol and menthol to impregnate inorganic porous particles allows for more efficacious antimicrobial action by thymol and menthol allowing faster antimicrobial action with a reduced amount of thymol and menthol.

Accordingly, in a first aspect the invention relates to impregnated inorganic porous particles comprising a eutectic mixture of thymol and menthol, wherein the weight ratio of thymol to menthol in the eutectic mixture is from 1:10 to 40:1; and the weight ratio of eutectic mixture to particles is from 1:0.5 to 1:10.

A second aspect of the invention relates to the aforementioned particles according to the invention obtainable by impregnating inorganic porous particles with a eutectic mixture of thymol and menthol.

A third aspect of the invention relates to a powder composition comprising the impregnated inorganic porous particles of the invention, further comprising an effervescent base.

A fourth aspect of the invention relates to a method of cleaning a surface comprising the steps of providing an aqueous solution comprising the impregnated particles or powder composition of the invention and contacting the surface with said aqueous solution.

### DETAILED DESCRIPTION OF THE INVENTION

As used herein the term “comprising” encompasses the terms “consisting essentially of” and “consisting of”. Where the term “comprising” is used, the listed steps or options need not be exhaustive. Unless otherwise specified, numerical ranges expressed in the format “from x to y” are understood to include x and y. Weight percentage (wt%) is calculated on total composition unless otherwise specified. Except in the operating and comparative examples, or where otherwise explicitly indicated, all numbers in this description indicating amounts of material or conditions of reaction, physical properties of materials and/or use are to be understood as modified by the word “about”. Room temperature is defined as a temperature of about 20 degrees Celsius.

### Eutectic Mixtures

A eutectic system is a mixture of chemical compounds or elements that has the lowest melting point of any other mixture made up of the same ingredients and wherein the composition of the liquid and the solid that are in equilibrium at this lowest melting temperature are the same. This composition is known as the “eutectic composition” and the corresponding melting temperature as the “eutectic temperature”.

The present invention relates to the mixture of two components that gives rise to a binary eutectic composition, i.e. a binary composition that has a lower melting point than any other composition made of the two components.

For the purpose of the present invention a “eutectic mixture” is defined as any binary mixture of the two components of the present invention that is in the liquid state above room temperature.

The present invention uses a eutectic mixture of thymol and menthol to impregnate inorganic porous particles. Eutectic mixtures of thymol and menthol as such are known to the skilled person. The weight ratio of thymol to menthol in the eutectic mixture is from 1:10 to 40:1 (e.g. a mixture of 1 gram thymol and 10 gram menthol would be a weight ratio of 1:10). Preferably the weight ratio of thymol to menthol in the eutectic mixture is from 1:10 to 20:1, more preferably 1:6 to 16:1, even more preferably 1:2 to 14:1, and still more preferably 1:1 to 12:1.

### Inorganic Porous Particles

The present invention concerns impregnated inorganic porous particles comprising the eutectic mixture of the invention. The term ‘impregnated’ would be understood as including sorption, and more specifically adsorption of the eutectic mixture, being a liquid, onto the surface of the solid inorganic particle.

Preferably the particles have an average volume based particle size of 5 to 30 μm, more preferably 10 to 25 μm, and even more preferably 15 to 20 μm. The particle size is measured at room temperature, with the particles dispersed in water using a Malvern Mastersizer™ or the like.

The particles preferably have an oil absorption of 150 to 400 gram per 100 gram particles, more preferably 180 to 370 gram, and even more preferably 210 to 340 gram.

Preferably the particles are silica particles, more preferably precipitated silica, like TC15 Silica that is commercially available as Sorbosil™ TC15 Silica. Preferably the particles are TC15 Silica.

The weight ratio of eutectic mixture to particles is from 1:0.5 to 1:10. Preferably the weight ratio of eutectic mixture to particles is from 1:1 to 1:10, more preferably 1:1 to 1:5, and even more preferably 1:1 to 1:2.

### Thymol

The eutectic mixture contains thymol. Thymol may be used in purified form. Alternatively, thyme oil or thyme extract comprising thymol may be used, while ensuring that thymol is present in the desired concentration in the eutectic mixture of the present invention. Preferably thymol is used in purified form.

Thyme oil or thyme extract is obtained from the thyme plant. Thyme plant refers to a plant belonging be genus Thymus and includes but is not limited to the following species: Thymus vulgaris, Thymus zygis, Thymus satureoides, Thymus mastichina, Thymus broussonetti, Thymus maroccanus, Thymus pallidus, Thymus algeriensis, Thymus serpyllum, Thymus pulegoide, and Thymus citriodorus.

Preferably the impregnated particles comprise at least 10 wt % of thymol, more preferably from 10 to 30 wt %, and even more preferably 15 to 25 wt %.

### Menthol

The eutectic mixture also contains menthol. Menthol may be used in purified form. Alternatively, menthol oil or menthol extract comprising menthol may be used, while ensuring that menthol is present in the desired concentration in the eutectic mixture of the present invention. Preferably menthol is used in purified form.

Menthol is selected from L-menthol, D-menthol and combinations thereof. Preferably menthol comprises L-menthol and most preferably is L-menthol.

### Impregnated Inorganic Porous Particles

It was surprisingly found that the impregnated inorganic porous particles of the invention give more efficacious antimicrobial action by thymol and menthol in an aqueous solution than an aqueous solution with a eutectic mixture of thymol and menthol without the particles, an aqueous solution made by separately adding the particles and a eutectic mixture of thymol and menthol, or an aqueous solution with any one of thymol and menthol.

Typically, the impregnated inorganic porous particles of the invention are made by preparing a eutectic mixture of thymol and menthol followed by combining the resulting eutectic mixture with the porous particles.

If so desired, additional ingredients can be added to the impregnated particles like colorants and fragrance. Such additions being done after or before the particles have been impregnated with the eutectic mixture. Preferably, the fragrance is a natural fragrance and preferable the fragrance is an essential oil like e.g. limonene or lemon grass oil. The amount of fragrance is from 0 to 10 wt %, preferably from 1 to 8 wt % and more preferably from 2 to 6 wt %. Other additional ingredients could e.g. be a surfactant like e.g. fatty acid, although it is preferred to limit the amount of such an ingredient. The amount of surfactant is from 0 to 10 wt %, preferable 0.1 to 6 wt % and more preferably from 0.15 to 3 wt %.

The present invention also concerns the impregnated inorganic porous particles of the invention obtainable by impregnating inorganic porous particles with a eutectic mixture of thymol and menthol.

### Powder Composition

Although the impregnated inorganic particles of the invention can be used as such, for example by contacting it with a to be cleansed surface, optionally in combination with water. A simple application could be applying the particles to hands and rubbing it, with or without water. Equally, this can be done for a hard surface like cutlery or dishes.

For more convenient and efficacious use of the impregnated inorganic particles of the invention the present invention also concerns a powder composition comprising the impregnated inorganic porous particles of the present invention, further comprising an effervescent base. Preferably the powder composition comprises from 1 to 99.5 wt % effervescent base, more preferably 5 to 99 wt %, even more preferably 10 to 98 wt %, and still even more preferably 20 to 95 wt %. A preferred powder composition comprises from 40 to 90 wt % effervescent base.

### Effervescent Base

Typically, the effervescent base comprises an organic acid and a carbonate salt which upon combining in the presence of water produce an effervescent reaction (i.e. generate carbon dioxide). The acid is preferably selected from tartaric acid, citric acid, fumaric acid, adipic acid, malic acid, oxalic acid, sulfamic acid and mixtures thereof. The carbonate salt is preferably selected from sodium carbonate, calcium carbonate, magnesium carbonate, ammonium carbonate, potassium carbonate, sodium bicarbonate, calcium bicarbonate and mixtures thereof. Preferably the amount of organic acid is in stoichiometric excess over the carbonate salt.

### Product Format

The powder composition can be packed in a bulk container, including formats like bottles and cartons, or packed in portions that allow for one time individual use, with a preferred format being a sachet.

It will be understood that the powder composition of the present invention can also be used to be pressed into a tablet format that will disintegrate upon contact with water. Such a tablet may comprise additional ingredients like filling agents to allow proper tablet formation.

Preferably the impregnated inorganic porous particles and powder composition of the invention comprise natural ingredients and more preferably at least 80 wt %, even more preferably at least 90 wt % and still even more preferably at least 95 wt % are natural ingredients. Preferably no synthetic chemicals are included.

### Method of Cleaning a Surface

The present invention also concerns a method of cleaning a surface comprising the steps of providing an aqueous solution comprising the impregnated particles or powder composition according to the present invention and contacting the surface with said aqueous solution.

Preferably the aqueous solution comprises a concentration of impregnated particles of 0.05 to 20 wt %, more preferably 0.05 to 10 wt %, even more preferably 0.1 to 5 wt % and still more preferably 0.1 to 1 wt %.

The term ‘contacting’ is to be understood as including submerging, wiping and scrubbing the surface with the resulting aqueous solution, optionally using an implement like e.g. a sponge or cloth. Preferably the surface is contacted with said aqueous solution for at least 15 seconds, more preferably from 15 to 60 seconds, and even more preferably from 30 to 45 seconds.

After the desired contact time, when the surface is cleaned, the surface can optionally be rinsed with water and/or wiped dry.

A typical application of said method includes providing an aqueous solution of from 50 to 150 ml, preferably 75 to 100 ml.

The method of the invention can e.g. be used to clean utensils like chopsticks. Typically, a consumer would use a sachet with a measured amount of powder composition to prepare an aqueous solution comprising a certain concentration of impregnated particles. The method would include adding the content of the sachet to a glass, or the like, of water and stirring the powder into the water with the to be cleaned chopsticks and leaving the chopsticks in the resulting aqueous solution for a set time like for example 30 seconds. The effervescent base provides a visual cue the consumer that a cleaning action is taking place, and also ensures proper distribution of the active ingredients. The chopsticks are now cleaned and can be used as such or optionally be rinsed in water and/or wiped dry before use.

The invention will now be illustrated by means of the following non-limiting examples.

### Examples

### Protocol for Testing Antimicrobial Efficacy

Antimicrobial efficacy was tested using British Standard 1040 20050001, using a contact time of 30 seconds and a starting inoculum of 10⁶ cells/ml, essentially comprising the following steps.

### Preparation of Test Culture Suspension

Stock suspension: A saline suspension of overnight grown agar plate culture of the test organism (Staphylococcus aureus ATCC 6538 or Escherichia coli ATCC 10536) was prepared. The OD was adjusted at 620 nm to obtain 10⁸ cells/ml. Working test suspension: The stock suspension was diluted 1:10 to obtain 10⁷ cells/ml. The diluted suspension was used for performing the contact time assay.

### Contact Time Assay

10 ml of the working test suspension and 90 ml of sterile distilled water were put in a sterile 250 ml glass bottle (starting inoculum).
The powder composition to be tested was then added (t=0) and a stop watch was started.
After 30 seconds, 1 ml of the reaction mixture was added to neutralizing broth.
Serial dilutions and plating were performed to enumerate the surviving bacterial population.
A culture control was set-up in parallel to determine the initial bacterial load.
The plates were incubated at 37° C. for 24 to 48 hours.
The log reduction was then calculated.

### General Protocol for Preparing Powder Compositions According to the Invention

### Impregnated porous particles

To prepare the impregnated porous particles, first a eutectic mixture of thymol and menthol was prepared by mixing thymol and menthol with shear until it became a homogenous liquid. The eutectic mixture was then combined with the porous particles and, when required, the fragrance.

### Powder Compositions

To prepare the powder compositions, the ingredients of the effervescent base (as indicated in the examples) were mixed with the prepared impregnated porous particles.

### Ingredients

Thymol was obtained from Ronak Fine Industries, India.

Menthol was obtained from Ronak Fine Industries, India.

Limonene was obtained from Ronak Fine Industries, India.

### Example 1—Antimicrobial Efficacy

The antimicrobial efficacy of various compositions, as indicated in Table 1, was tested using the test protocol described above.

All compositions (comparatives A to D and sample 1 according to the invention) comprised an effervescent base consisting of 1.1 gram tartaric acid and 1.3 gram sodium bicarbonate.

Sample A: thymol and effervescent base were added as is to the test suspension.

Sample B: menthol and effervescent base were added as is to the test suspension.

Sample C: thymol, menthol and effervescent base were added as is to the test suspension.

Sample D: thymol and menthol were provided as a eutectic mixture, but the eutectic mixture was not used to impregnate the silica TC15 particles. The eutectic, silica and effervescent base were added as is to the test suspension.

Sample 1: silica TC15 particles were pre-loaded with the eutectic mixture of thymol and menthol. The impregnated particles and effervescent base were added as is to the test suspension.

TABLE 1

| | | Antimicrobial |
|---|---|---|
| | Composition as indicated + effervescent | Efficacy |
| Sample | base | (S. aureus) |
| A | Thymol (0.05 gram) | No efficacy |
| B | Menthol (0.05 gram) | No efficacy |
| C | Thymol (0.05 gram) + menthol (0.05 gram) | <2 log reduction |
| D | Eutectic mixture of thymol (0.05 gram) and | <2 log reduction |
| | menthol (0.05 gram) + Silica T15 (0.15 | |
| | gram) | |
| 1 | Silica T15 (0.15 gram) pre-loaded with | >4 log reduction |
| | eutectic mixture of thymol (0.05 gram) and | |
| | menthol (0.05 gram) | |

### Example 2—Weight Ratio of Eutectic Mixture and Particles

The antimicrobial efficacy of various compositions, as indicated in Table 2, was tested using the test protocol described above.

All compositions (samples 1 to 5 according to the invention) comprised an effervescent base consisting of 1.1 gram tartaric acid and 1.3 gram sodium bicarbonate.

TABLE 2

| | Composition as indicated + | | Antimicrobial |
|---|---|---|---|
| Sample | effervescent base | wt ratio* | Efficacy |
| 1 | Silica T15 (0.1 gram) pre-loaded with | 1:1 | >4 log reduction |
| | eutectic mixture of thymol (0.05 | | E. coli |
| | gram) and menthol (0.05 gram) | | ~3 log reduction |
| | | | S. aureus |
| 2 | Silica T15 (0.15 gram) pre-loaded | 1:1.5 | >4 log reduction |
| | with eutectic mixture of thymol (0.05 | | E. coli and |
| | gram) and menthol (0.05 gram) | | S. aureus |
| 3 | Silica T15 (0.2 gram) pre-loaded | 1:2 | >4 log reduction |
| | with eutectic mixture of thymol (0.05 | | E. coli and |
| | gram) and menthol (0.05 gram) | | S. aureus |
| 4 | Silica T15 (0.3 gram) pre-loaded | 1:3 | >4 log reduction |
| | with eutectic mixture of thymol (0.05 | | E. coli and |
| | gram) and menthol (0.05 gram) | | S. aureus |
| 5 | Silica T15 (0.4 gram) pre-loaded | 1:4 | >4 log reduction |
| | with eutectic mixture of thymol (0.05 | | E. coli and |
| | gram) and menthol (0.05 gram) | | S. aureus |

*weight ratio of eutectic mixture to silica

### Example 3—Weight Ratio of Thymol to Menthol

Various weight ratios of thymol to menthol were tested as indicated in Table 3. The antimicrobial efficacy of the compositions was tested using the test protocol described above.

TABLE 3

| | Composition as indicated + | | Antimicrobial |
|---|---|---|---|
| Sample | effervescent base | wt ratio* | Efficacy |
| 1 | Silica T15 (0.15 gram) pre-loaded | 1:1 | >4 log reduction |
| | with eutectic mixture of thymol (0.05 | | E. coli and |
| | gram) and menthol (0.05 gram) | | S. aureus |
| 2 | Silica T15 (0.15 gram) pre-loaded | 1:0.5 | >4 log reduction |
| | with eutectic mixture of thymol (0.05 | | E. coli and |
| | gram) and menthol (0.025 gram) | | S. aureus |
| 3 | Silica T15 (0.15 gram) pre-loaded | 1:0.2 | >4 log reduction |
| | with eutectic mixture of thymol (0.05 | | E. coli and |
| | gram) and menthol (0.01 gram) | | S. aureus |
| 4 | Silica T15 (0.15 gram) pre-loaded | 1:0.1 | >4 log reduction |
| | with eutectic mixture of thymol (0.05 | | E. coli and |
| | gram) and menthol (0.005 gram) | | S. aureus |

*weight ratio of thymol to menthol

Example 4—Method of Cleaning of Chopsticks

A powder composition according to the invention was made. Impregnated inorganic porous particles having the composition as in Table 4 were prepared by mixing silica TC15 with limonene and then adding a eutectic mixture of thymol and menthol. The resulting impregnated particles where then mixed with an effervescent base of tartaric acid and sodium bicarbonate as in Table 5.

TABLE 4
impregnated particles

| Ingredients | Amount (g) |
|---|---|
| Thymol | 5 |
| Menthol | 0.5 |
| Limonene | 3 |
| Silica TC15 | 20 |
| Total | 28.5 |

TABLE 5
powder composition

| Ingredients | Amount (g) |
|---|---|
| Particles | 0.3 |
| Tartaric acid | 1.1 |
| Sodium bicarbonate | 1.3 |
| Total | 2.7 |

The resulting powder composition of Table 5 was then added to 100 ml of water in a glass and a pair of chopsticks to be cleaned were used to give it a quick stir and then left in the aqueous solution for 30 seconds after the chopsticks were taken out of the water and wiped dry with a cloth.

1. Impregnated inorganic porous particles comprising a eutectic mixture of thymol and menthol, wherein the weight ratio of thymol to menthol in the eutectic mixture is from 1:10 to 40:1; and the weight ratio of eutectic mixture to particles is from 1:0.5 to 1:10.

2. The particles according to claim 1 wherein the particles have an average volume based particle size of 5 to 30 μm.

3. The particles according to claim 1, wherein the particles have an oil absorption of 150 to 400 gram per 100 gram particles.

4. The particles according to claim 1 wherein the particles are precipitated silica.

5. The particles according to claim 1 wherein the weight ratio of thymol to menthol in the eutectic mixture is from 1:10 to 20:1.

6. The particles according to claim 1 wherein the weight ratio of eutectic mixture to particles is from 1:1 to 1:10.

7. The particles according to claim 1 comprising at least 10 wt % of thymol.

8. The particles according to claim 1 comprising a fragrance, preferably a natural fragrance, and more preferably a fragrance being an essential oil.

9. The particles according to claim 1 obtainable by impregnating inorganic porous particles with a eutectic mixture of thymol and menthol.

10. A powder composition comprising the impregnated inorganic porous particles of claim 1, further comprising an effervescent base.

11. The powder composition according to claim 10 comprising from 1 to 99.5 wt % effervescent base.

12. The powder composition according to claim 10, wherein the powder composition is pressed into a tablet format, optionally comprising filling agent.

13. A method of cleaning a surface comprising the steps of providing an aqueous solution comprising the impregnated particles or powder composition of claim 1 and contacting the surface with said aqueous solution.

14. The method according to claim 13 wherein the aqueous solution comprises a concentration of impregnated particles of 0.05 to 20 wt %.

15. The method according to claim 13 wherein the surface is contacted with said aqueous solution for at least 15 seconds.
